(19) United States
(12) Patent Application Publication
(10) Pub. No.: US 2017/0017370 A1
(43) Pub. Date: Jan. 19, 2017

(54) DEVICE AND METHOD FOR PROCESSING DATA

(71) Applicant: ALIBABA GROUP HOLDING LIMITED, George Town (KY)

(72) Inventor: Xiaoming WANG, Hangzhou (CN)

(73) Assignee: ALIBABA GROUP HOLDING LIMITED

(21) Appl. No.: 15/210,574

(22) Filed: Jul. 14, 2016

(30) Foreign Application Priority Data
Jul. 14, 2015 (CN) 201510412872.3

(51) Int. Cl. G06F 3/0486; G06F 9/54; G06F 3/0484

(52) U.S. Cl. CPC G06F 3/0486; G06F 3/04842; G06F 9/543

(57) ABSTRACT

A device for copying target data and pasting the target data to a target location is provided. The device includes a memory device storing instructions; and a processor configured to execute the instructions stored in the memory device to: determine pasting location information based on a user paste operation in an input area; and paste the target data at the target location in the input area determined based on the pasting location information.

### CROSS-REFERENCE TO RELATED APPLICATIONS

This application is based upon and claims priority to Chinese Patent Application No. 201510412872.3, filed Jul. 14, 2015, the entire contents of which are incorporated herein by reference.

### TECHNICAL FIELD

The present disclosure generally relates to the field of computer technology, and more particularly, to a device and method for processing data.

### BACKGROUND

When a user employs an electronic terminal to acquire information, copying and pasting are two of most common and frequently used operations. For example, a user may wish to use a terminal to copy and paste content such as text or pictures. The conventional copying and pasting functions do not automatically and accurately paste the desired content to a user-desired location. The user is required to manually move the desired content to a correct location after it is pasted. Such steps are tedious, inconvenient, and inefficient.

### SUMMARY

Consistent with embodiments of the present disclosure, there is provided a device for copying target data and pasting the target data to a target location. The device includes a memory device storing instructions; and a processor configured to execute the instructions stored in the memory device to: determine pasting location information based on a user paste operation in an input area; and paste the target data at the target location in the input area determined based on the pasting location information.

Consistent with embodiments of the present disclosure, there is provided a computer-implemented method for copying target data and pasting the target data to a target location. The method includes: determining pasting location information based on a user paste operation in an input area; and pasting the target data at the target location in the input area determined based on the pasting location information.

Consistent with embodiments of the present disclosure, there is provided a non-transitory computer readable medium that stores a set of instructions that are executable by at least one processor of a data-processing device to cause the device to perform a method, the method including: determining pasting location information based on a user paste operation in an input area; and pasting target data at a target location in the input area determined based on the pasting location information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a block diagram of an exemplary device for processing data, consistent with embodiments of the present disclosure.

FIG. 2 illustrates exemplary alignment methods, consistent with embodiments of the present disclosure.

FIG. 3 is illustrates positioning of a pasted content in an input area, consistent with embodiments of the present disclosure.

FIG. 4 is a flow chart illustrating a method for processing data, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The present disclosure provides a method and device that assist and facilitate the user by determining pasting location information based on a user paste operation in an input area, and pasting target data at a location in the input area based on the pasting location information. Further, the method and device consistent with embodiments of the present disclosure can paste the target data at a location in the input area based on pasting location information and an alignment method to provide a friendly human-machine interface that improves user experience and work efficiency. Further, the method and device consistent with embodiments of the present disclosure can display pasting location to even more accurately paste the target data.

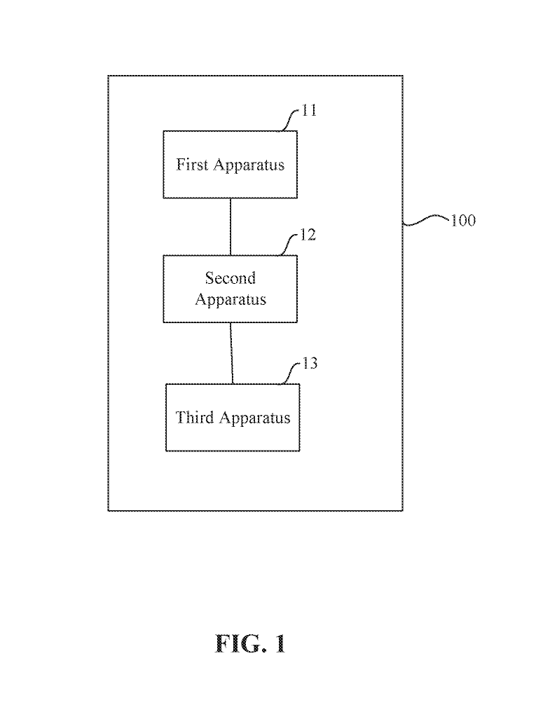

FIG. 1 is a block diagram of an exemplary device 100 for processing data, consistent with embodiments of the present disclosure. Referring to FIG. 1, the device 100 includes a first apparatus 11 and a second apparatus 12.

The first apparatus 11 is configured to, based on a user paste operation in an input area, determine pasting location information. The second apparatus 12 is configured to, based on the pasting location information, paste target data at a location in the input area corresponding to the pasting location information.

In some embodiments, the first apparatus 11 includes a positioning module configured to select a location according to a user operation in the input area. The second apparatus 12 includes a pasting module configured to paste the target data at the selected location. For the purpose of explaining the present disclosure, the first apparatus 11 and positioning module are used interchangeably; the second apparatus 12 and the pasting module are used interchangeably.

In the illustrated embodiment, the input area is an operation area where a user edits text, a picture, or other format of data. The target data includes text, table, graph, and image data, etc., queued to be pasted.

In some embodiments, the positioning module determines pasting location information based on a user's paste operation in an input area. For example, the user may click in the input area to generate a coordinate point to determine the pasting location. Alternatively, the user may click and drag or click multiple times to form an enclosed area in the input area in order to determine the pasting location. The input device may include a computer mouse, a keyboard, a stylus, a touch screen, a tracking ball, or a tracking wheel. The present disclosure allows a user to freely define a point or an enclosed area for pasting the target data thereat.

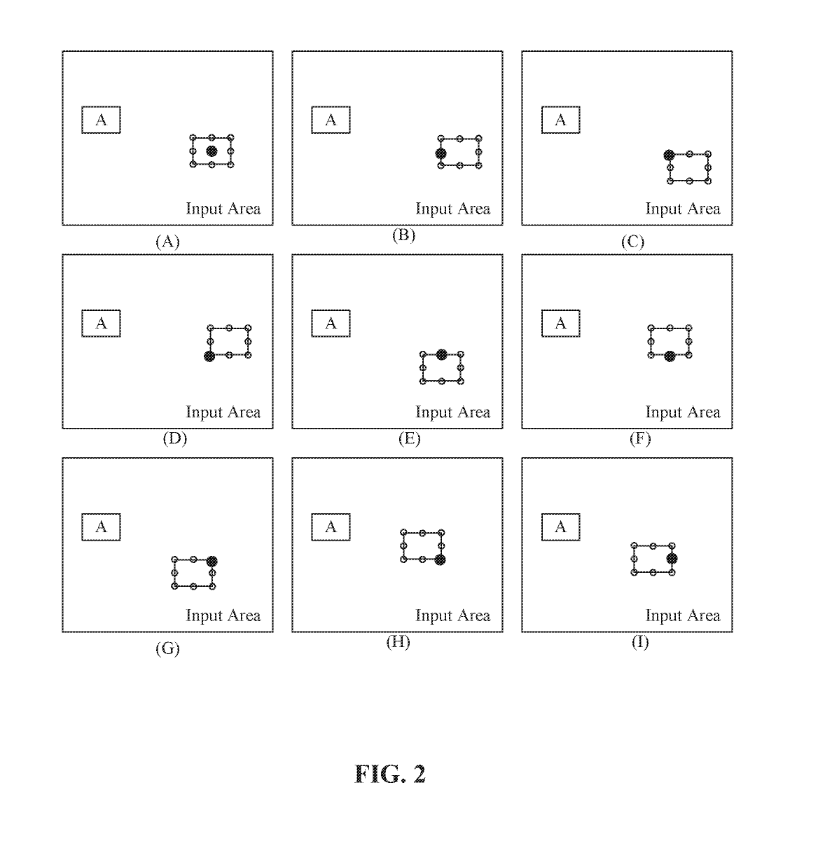

In the illustrated embodiment, based on the pasting location information, the pasting module pasts the target data at a position in the input area. For example, the user enters the software operation area and draws an element “A”. Element “A” is thus the target data. The user selects and copies element “A”, and then uses an input device, e.g., a mouse, to perform an operation, e.g., click on the left button of the mouse, in a blank space of the software operation area. A coordinate point will be generated at the place clicked by the user. To perform a direct pasting, the user can press the “Ctrl+V” keys or click right button of the mouse to paste the target data “A” to the coordinate point. By default, the center of pasted target data “A” is aligned with the coordinate point. Targeted data “A” may remain selected. If not directly pasting, the user can move the mouse and right click the coordinate point to show a plurality of alignment choices. For example, as shown in FIG. 2, the alignment choices include aligning the center (FIG. 2(A)), mid-point on the left side (FIG. 2(B)), upper left corner (FIG. 2(C)), lower left corner (FIG. 2(D)), mid-point on the upper side (FIG. 2(E)), mid-point on the lower side (FIG. 2(F)), upper right corner (FIG. 2(G)), mid-point on the right side (FIG. 2(H)), or lower right corner (FIG. 2(I)) of the target data “A” to the selected coordinate point. In FIG. 2, the solid point represents the pasting location and the hollow points represent the alignment choices of the target data. In one embodiment, a pop-up window is shown after the user right clicks the coordinate point. The user can then select to align the upper left corner of the target data to the coordinate point for pasting the target data, as shown in FIG. 2(C).

As explained above, the positioning module determines a user copying operation performed on the target data in a copying area. Consistent with this disclosure, a copying area is an area in which the target data to be copied is located. In some embodiments, the copying area may be in a same application or a different application as the input area. For example, when the user wishes to copy target data from a piece of office software, e.g., Microsoft WORD, and paste it to a drawing area of, for example, Microsoft Office Visio, the user can press the “Ctrl+C” keys or the right button of a mouse to select the “copy” function to perform a copy operation to copy the target data in a copy area. The device 100 detects the user's copy operation and, based on user's paste operation in the input area of Microsoft Office Visio, pastes the selected target data thereto. As another example, copying and pasting of the target data can be performed in the same drawing window of software, e.g., Adobe Photoshop, or different drawing windows of Adobe Photoshop.

One of ordinary skill in the art would understand that WORD is a word processing application; that Microsoft Office Visio is a piece of software that visualizes, analyze, and interact with complex messages, systems, and flow plans; and that Adobe Photoshop is a piece of image processing software that mainly processes digitized images having pixels, to effectively edit the images.

In some embodiments, a time difference between a copy operation and a paste operation is equal to or less than a predetermine threshold time period. In the illustrated embodiment, the sequence of the copy and paste operations is not limited. The copy operation can be performed before or after the paste operation, as long as the time difference between them is equal to or less than the predetermined threshold time period. For example, the predetermined threshold time period is fifteen seconds. For example, if the time difference between the copy operation and the paste operation is equal to or less than fifteen seconds, the terminal can paste the target data to the input area. If the time difference between the copy operation and the paste operation is greater than fifteen seconds, the target data in the copy operation is not pasted to the input area during the paste operation.

In some embodiments, a paste operation includes one of performing a click operation in an input area; performing a click and drag operation in the input area; and performing multiple click operations in the input area. To paste the target data at a location in the input area, the location needs to be determined. The location in the input area for pasting the target data can be determined using the three methods explained above. For example, a pasting location can be determined by clicking the left button of a mouse or by clicking the left button of a mouse and dragging without releasing the left button to form an enclosed area, such as a rectangle, a circle, an oval, a square, etc. A pasting location can also be determined by performing multiple clicks on different points in the input area, in which a distance between two clicks is smaller than a predetermined threshold distance, to form an enclosed area. The enclosed area determined above is the input area in which the target data is pasted.

On of ordinary skill in the art would understand that the above methods for determining a pasting location are provided as examples and do not limit the scope of the present disclosure. Other computer-assisted methods that can be employed to determine a pasting location are in the contemplated scope of the present disclosure.

In some embodiments, a paste operation includes performing a click operation in the input area. The pasting location information includes coordinate information generated based on the click operation. For example, a user may use a mouse to freely click at a first point in the input area to generate a pair of x, y coordinates of the first point. The location of the first point is, for example, the pasting location information. The pasting module 12 is configured to detect the user operation selecting a point in the input area. After the mouse is moved, the first point does not disappear. The user may click at a second point. When a distance between the first point and the second point is greater than a predetermined distance, the first point disappears and the coordinates of the second point become the pasting location information. For example, the user first clicks at point A but finds that point A is not a desired location for pasting an image. The user then clicks at point B. If the distance between point A and point B is greater than the predetermined distance, point A disappears from the input area and point B remains therein. Point B becomes the effective location for pasting the image.

In some embodiments, a paste operation includes a plurality of click operations in the input area. The pasting location information includes enclosed area information generated based on the plurality of click operations that generate points to form an enclosed area. The pasting module 12 is configured to detect the user operation selecting a plurality of points in the input area and form an enclosed area based on the selected points. For example, the target data may include text and a plurality of graphs (hybrid data). The user selects and performs a copy operation of the hybrid data, and the selected area forms a rectangular shape bounding box. The hybrid data in the rectangular bounding box is then pasted in the input area. For example, the user may perform four click operations in sequence at four different points in the input area to form an enclosed rectangular area such that the copied hybrid data can be pasted therein.

In some embodiments, a paste operation includes a click and drag operation in the input area. The pasting location information includes at least one of inputting a start point and an end point in the input area to form a rectangular area. The click and drag operation forms an enclosed area in the input area based on a trajectory of the drag operation.

In the illustrated embodiment, the click and drag operation includes at least one of the following operations. First, the click and drag operation forms a rectangular area by determining a first point in the input area as a start point, and dragging the mouse without releasing the pressed left button until reaching a second point in the input area. The first and second points form a diagonal line of the rectangular area. That is, the pasting module 12 is configured to detect the user operation drawing a line having a start point and an end point in the input area and form a rectangle using the line as a diagonal line of the rectangle. Second, a click and drag operation forms an enclosed area in the shape of a circle or an oval, etc. by dragging the mouse in the input area. That is, the pasting module 12 is configured to detect a user operation drawing an enclosed area in the input area. The target data can then be pasted in the enclosed area formed by either of the above two methods.

One of ordinary skill in the art would understand that using a mouse to form an enclosed area is merely exemplary. A user may also use his/her finger to draw an enclosed area on a touch screen. Other suitable computer-assisted methods that can form an enclosed area for pasting the target data are within the contemplated scope of the present disclosure.

In some embodiments, the paste module 12 paste the target data onto an area in the input area based on pasting location information and a selected alignment method. After determining a pasting location, to perform a direct pasting, the user presses the “Ctrl+V” keys or clicks right button of the mouse to paste the target data. By default, the center of the target data is aligned with the pasting location, and the target data will remain selected. When not performing a direct pasting, the user can move the mouse and right click on the pasting location to show multiple alignment choices. The pasting module 12 pastes the target data according to one of the alignment choice once the alignment choice is selected. In some embodiments, a click on a location in the input area out of the alignment choice window closes the alignment choice window. For example, as shown in FIG. 2, the alignment choices include aligning the center, upper left corner, mid-point on the left side, lower left corner, mid-point on the upper side, mid-point on the lower side, upper right corner, mid-point on the right side, or lower right corner of the target data to the selected coordinate point.

In some embodiments, the target data to be pasted include image information. For example, the target data includes image formats including .jpg, .jpeg, .gif, .png, or .bmp, etc.

In some embodiments, the paste module 12 pastes the target data into a target area formed by a user operation in the input area based on pasting location information, and enlarges or shrinks the area of the target data to fit the target data into the target area. When the area of the target data is larger than the target area, a length or width of the area of the target data can be shrunken or the area of the target data can be proportionally shrunken to fit into the target area in the input area. In some embodiments, after the target data is pasted into the target area in the input area, the size of the target data may be further adjusted based on a user preference.

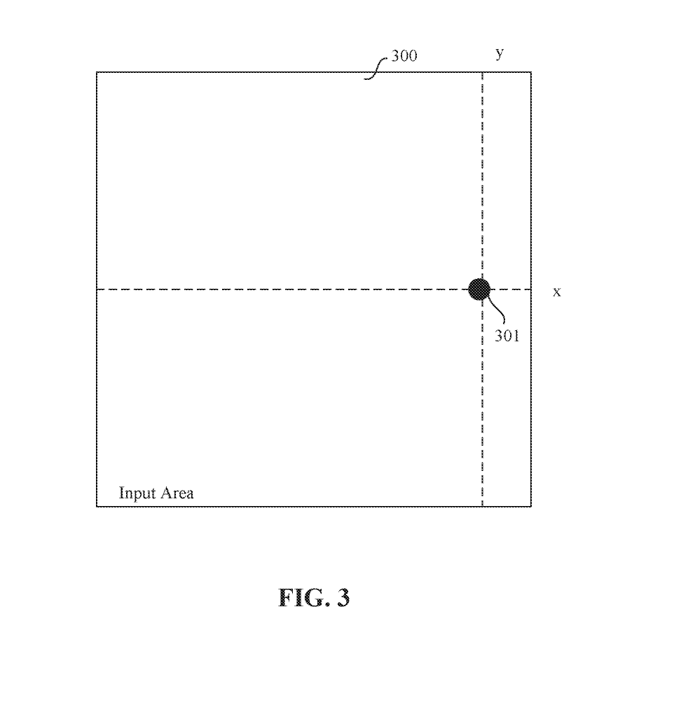

In some embodiments, referring again to FIG. 1, the device 100 for processing data further includes a third apparatus 13 configured to display pasting location information in the input area. For example, the third module 13 can be a display module, which displays a coordinate point after a click operation in the input area. For example, the third module 13 uses a color or blink to show a selected pasting location. FIG. 3 is a schematic diagram illustrating a pasting location 301 in an input area 300. The use may click a left button of a mouse to select a pasting location 301 in the input area 300 so that the target data can be pasted onto the pasting location 301. However, it is contemplated that the present disclosure is not limited in the above example of employing a mouse to select a pasting location. Other computer-assisted methods that can select a pasting location for pasting the target data are in the contemplated scope of the present disclosure.

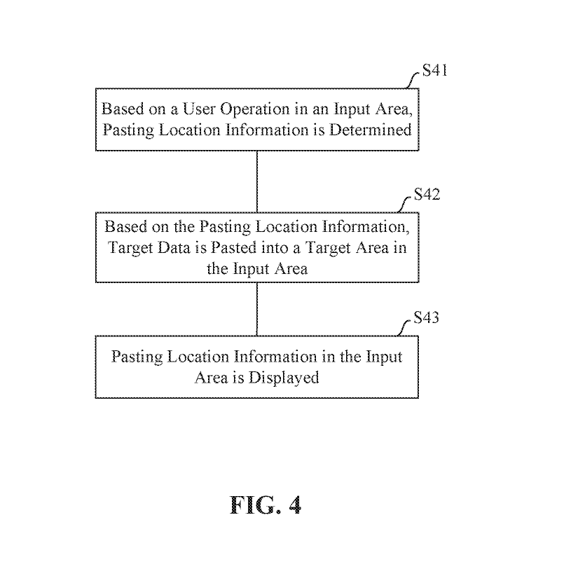

FIG. 4 is a flow chart illustrating a method 400 for processing data, consistent with embodiments of the present disclosure. The method 400 may be performed by a data processing device, such as the device 100. Referring to FIG. 4, the method 400 includes steps S41 and S42.

In step S41, based on a user operation in an input area, pasting location information is determined. In step S42, based on the pasting location information, target data is pasted into a corresponding area in the input area.

In the illustrated embodiment, the input area is an operation area where a user edits a text, a picture, or other format of data. The target data includes text, table, graph, and picture data, etc., queued to be pasted.

In some embodiments, in step S41, a device for processing data determines the pasting location information based on the user operation in the input area. For example, the user may click in the input area to generate a coordinate point to determine the pasting location. Alternatively, the user may click and drag or click multiple times to form an enclosed area in the input area in order to determine the pasting location. The input device may include a computer mouse, a keyboard, a stylus, a touch screen, a tracking ball, or a tracking wheel. The present disclosure allows a user to freely define a point or an enclosed area for pasting the target data thereat.

In some embodiments, in step S42, based on the pasting location information, the device pastes the target data at a location in the input area. For example, the user enters the software operation area and draws an element “A”. Element “A” is thus the target data. The user selects and copies element “A”, and then uses an input device, e.g., a mouse, to perform an operation, e.g., click on the left button of the mouse, in a blank space of the software operation area. A coordinate point will be generated at the place clicked by the user. To perform a direct pasting, the user can press the “Ctrl+V” keys or click right button of the mouse to paste the target data “A” to the coordinate point. By default, the center of pasted target data “A” is aligned with the coordinate point. Targeted data “A” may remain selected. If not directly pasting, the user can move the mouse and right click the coordinate point to show a plurality of alignment choices, as shown in FIG. 2. The user then selects one of the alignment choices to paste the target data.

In some embodiments, the step S41 further includes copying the target data from a copying area. Consistent with this disclosure, a copying area is an area in which the target data to be copied is located. In some embodiments, the copying area may be in a same application or a different application as the input area. For example, when the user wishes to copy target data from a piece of office software, e.g., Microsoft WORD, and paste it to a drawing area of, for example, Microsoft Office Visio, the user can press the “Ctrl+C” keys or the right button of a mouse to select the “copy” function to perform a copy operation to copy the target data in a copy area. The device 100 detects the user's copy operation and, based on user's paste operation in the input area of Microsoft Office Visio, pastes the selected target data thereto. As another example, copying and pasting of the target data can be performed in the same drawing window of software, e.g., Adobe Photoshop, or different drawing windows of Adobe Photoshop.

One of ordinary skill in the art would understand that WORD is a word processing application, that Microsoft Office Visio is a piece of software that visualizes, analyze, and interact with complex messages, systems, and flow plans; and that Adobe Photoshop is a piece of image processing software that mainly processes digitized images having pixels, to effectively edit the images.

In some embodiments, the device determines whether a time difference between a copy operation and a paste operation is equal to or less than a predetermine threshold time period. In the illustrated embodiment, the sequence of the copy and paste operations is limited. The copy operation can be performed before or after the paste operation, as long as the time difference between them is equal to or less than the predetermined threshold time period. For example, the predetermined threshold time period is fifteen seconds. For example, if the time difference between the copy operation and the paste operation is equal to or less than fifteen seconds, the terminal can paste the target data to the input area. If the time difference between the copy operation and the paste operation is greater than fifteen seconds, the target data in the copy operation is not pasted to the input area during the paste operation.

In some embodiments, a paste operation includes one of performing a click operation in an input area; performing a click and drag operation in the input area; or performing multiple click operations in the input area. To paste the target data to a location in the input area, the location needs to be determined. The location in the input area for pasting the target data can be determined using the three methods explained above. For example, a pasting location can be determined by clicking the left button of a mouse or by clicking the left button of a mouse and dragging without releasing the left button to form an enclosed area, such as a rectangle, a circle, an oval, a square, etc. A pasting location can also be determined by performing multiple clicking on different points in the input area, in which a distance between two clicks/points is smaller than a predetermined threshold distance, to form an enclosed area. The enclosed area determined above is the input area in which the target data is pasted.

On of ordinary skill in the art would understand that the above methods for determining a pasting location are provided as examples. The present disclosure is not so limited. Other computer-assisted methods that can be employed to determine a pasting location are in the contemplated scope of the present disclosure.

In some embodiments, a paste operation includes performing a click operation in the input area. The pasting location information includes coordinate information generated based on the click operation. For example, a user may use a mouse to freely click at a first point in the input area to generate a pair of x-, y-axis coordinates of the first point. The location of the first point is, for example, the pasting location information. After the mouse is moved, the first point does not disappear. The user may click at a second point. When a distance between the first point and the second point is greater than a predetermined distance, the first point disappears and the coordinates of the second point become the pasting location information. For example, the user first clicks at point A but finds that point A is not a desired location for pasting an image. The user then clicks at point B. If the distance between point A and point B is greater than the predetermined distance, point A disappears from the input area and point B remains therein. Point B becomes the effective location for pasting the image.

In some embodiments, a paste operation includes a plurality of click operations in the input area. The pasting location information includes enclosed area information generated based on the plurality of click operations that generate points forming an enclosed area. For example, the target data may include text and a plurality of graphs (hybrid data. The user selects and performs a copy operation of the hybrid data, and the selected area forms a rectangular shape bounding box. The hybrid data in the rectangular bounding box is then pasted in the input area. For example, the user may perform four click operations in sequence at four different points in the input area to form an enclosed rectangular area such that the copied hybrid data can be pasted therein.

In some embodiments, a paste operation includes a click and drag operation in the input area. The pasting location information includes at least one of inputting a start point and an end point in the input area to form a rectangular area. The click and drag operation forms an enclosed area in the input area based on a trajectory of the drag operation.

In the illustrated embodiment, the click and drag operation includes at least one of the following operations. First, the click and drag operation forms a rectangular area by determining a first point in the input area as a start point, and dragging the mouse without releasing the pressed left button until reaching a second point in the input area. The first and second points form a diagonal line of the rectangular area. That is, the pasting module 12 is configured to detect the user operation drawing a line having a start point and an end point in the input area and form a rectangle using the line as a diagonal line of the rectangle. Second, a click and drag operation forms an enclosed area in the shape of a circle or an oval, etc. by dragging the mouse in the input area. The target data can then be pasted in the enclosed area formed by either of the above two methods.

One of ordinary skill in the art would understand that using a mouse to form an enclosed area is merely exemplary. A user may also use his/her finger to draw an enclosed area on a touch screen. Other suitable computer-assisted methods that can form an enclosed area for pasting the target data are within the contemplated scope of the present disclosure.

In some embodiments, the step S42 includes pasting the target data onto an area in the input area, based on pasting location information and a selected alignment method. After determining a pasting location, to perform a direct pasting, the user presses the “Ctrl+V” keys or clicks right button of the mouse to paste the target data. By default, the center of the target data is aligned with the pasting location, and the target data will remain selected. When not performing a direct pasting, the user can move the mouse and right click on the pasting location to show multiple alignment choices. The pasting module 12 pastes the target data according to one of the alignment choice once the alignment choice is selected. In some embodiments, a click on a location in the input area out of the alignment choice window closes the alignment choice window. Exemplary alignment choices are explained above with respect to FIG. 2.

In some embodiments, the target data to be pasted include image information. For example, the target data includes image formats including .jpg, .jpeg, .gif, .png, or .bmp, etc.

In some embodiments, the step S42 includes pasting the target data into a target area in the input area based on pasting location information, and enlarging or shrinking the area of the target data to fit the target data into the target area. When the area of the target data is larger than the target area, a length or width of the area of the target data can be shrunken or the area of the target data can be proportionally shrunken to fit into the target area in the input area. In some embodiments, after the target data is pasted into the target area in the input area, the size of the target data may be further adjusted based on a user preference.

In some embodiments, referring again to FIG. 4, the method 400 for processing data further includes step S43. In the step S43, pasting location information in the input area is displayed. For example, the data-processing device may include a display module, which displays a coordinate point after a click operation in the input area. For example, a color or blink can be employed to show a selected pasting location. However, it is contemplated that the present disclosure is not limited in the above example of employing a mouse to select a pasting location. Other computer-assisted methods that can select a pasting location for pasting the target data are in the contemplated scope of the present disclosure.

The illustrated methods and modules may be implemented by software, hardware, or a combination of software and hardware for allowing a specialized device incorporating the specific components to perform the functions described above. For example, they may be implemented in an application-specific integrated circuit (ASIC), computers, or other hardware devices. In one embodiment, the steps and functions of a unit can be performed by a physical processor. In one embodiment, the steps and their relevant data structures can be stored in a non-transitory computer-readable storage medium, such as a RAM, a magnetic or optical drive, a magnetic disc and the like. In some embodiments, the steps or functions of the present disclosure can be implemented with hardware devices, such as circuits designed to work with the processor to execute the steps or functions.

The device for processing data consistent with the embodiments of the present disclosure may include one or more processors, input/output ports, network connectors, and memory devices.

The non-transitory computer-readable medium may store instructions, which, when executed by the one or more processors, cause the processors to perform the methods described above. The medium may be random access memory (RAM), or other non-volatile memory, such as read only memory (ROM), one or more caches, one or more registers, or flash memory. The memory device can be part of the device for processing data or separate and independent from it.

The non-transitory computer-readable medium can permanently or temporarily store information. It can be a mobile or stationary medium. The information may be computer-readable instructions, data structures, process modules, or other data. The computer-readable medium may include phase-change random access memory (PRAM), static random-access memory (SRAM), dynamic random-access memory (DRAM), other types of RAM, Electrically Erasable Programmable Read-Only Memory (EEPROM), CD, DVD, other types of optical storage medium, magnetic tapes, magnetic drives, or other types of magnetic storage medium, to storage computer messages.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims. One of ordinary skill in the art will also understand that multiple ones of the above described steps or units may be combined as one step or unit, and each of the above described units may be further divided into a plurality of sub-units. A singular expression of a term in the present disclosure does not exclude that it can be plural. The ordinal numbers used in the present disclosure does not necessarily present the order of the steps or methods. The order of the steps or methods may be modified according to the practical needs.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1.-22. (canceled)

23. A device for copying target data and pasting the target data to a target location, comprising:
a memory device storing instructions; and
a processor configured to execute the instructions stored in the memory device to:
determine pasting location information based on a user paste operation in an input area; and
paste the target data at the target location in the input area determined based on the pasting location information.

24. The device of claim 23, wherein the processor is further configured to:
detect a user copy operation to copy the target data from a copy area.

25. The device of claim 24, wherein a time difference between the copy operation and the paste operation is equal to or less than a predetermined threshold time period.

26. The device of claim 23, wherein the paste operation includes a click operation in the input area, wherein in the click operation, the processor is configured to detect a user operation selecting a point in the input area, wherein the pasting location information includes coordinate information corresponding to the selected point.

27. The device of claim 23, wherein the paste operation includes a click and drag operation in the input area, wherein in the click and drag operation, the processor is configured to:
detect a user operation drawing a line having a start point and an end point in the input area and form a rectangle using the line as a diagonal line of the rectangle; or
detect a user operation drawing an enclosed area in the input area.

28. The device of claim 23, wherein the paste operation includes a plurality of click operations in the input area, wherein in the plurality of click operations, the processor is configured to detect a user operation selecting a plurality points in the input area and form an enclosed area based on the selected points.

29. The device of claim 23, wherein the processor is further configured to:
receive a user selection of an alignment method; and
paste the target data at a location in the input area based on the pasting location information and the selected alignment method indicating how the target data is aligned with the location obtained based on the pasting location information.

30. The device of claim 23, wherein the processor is further configured to:
enlarge or shrink an area of the target data to fit the target data into the location obtained based on the pasting location information.

31. A computer-implemented method for copying target data and pasting the target data to a target location, comprising:
determining pasting location information based on a user paste operation in an input area; and
pasting the target data at the target location in the input area determined based on the pasting location information.

32. The computer-implemented method of claim 31, further comprising:
detecting a user copy operation to copy the target data from a copy area.

33. The computer-implemented method of claim 32, wherein a time difference between the copy operation and the paste operation is equal to or less than a predetermined threshold time period.

34. A non-transitory computer readable medium that stores a set of instructions that is executable by at least one processor of a data-processing device to cause the device to perform a method, the method comprising:
determining pasting location information based on a user paste operation in an input area; and
pasting target data at a target location in the input area determined based on the pasting location information.

35. The non-transitory computer readable medium of claim 34, wherein the method further comprises:
detecting a user copy operation to copy the target data from a copy area.

36. The non-transitory computer readable medium of claim 35, wherein a time difference between the copy operation and the paste operation is equal to or less than a predetermined threshold time period.

37. The non-transitory computer readable medium of claim 34, wherein the paste operation includes a click operation in the input area, wherein the click operation includes detecting a user operation selecting a point in the input area, wherein the pasting location information includes coordinate information corresponding to the selected point.

38. The non-transitory computer readable medium of claim 34, wherein the paste operation includes a click and drag operation in the input area, wherein the click and drag operation includes:
detecting a user operation drawing a line having a start point and an end point in the input area and forming a rectangle using the line as a diagonal line of the rectangle; or detecting a user operation drawing an enclosed area in the input area.

39. The non-transitory computer readable medium of claim 34, wherein the paste operation includes a plurality of click operations in the input area, wherein the plurality of click operations include detecting a user operation selecting a plurality points in the input area and forming an enclosed area based on the selected points.

40. The non-transitory computer readable medium of claim 34, wherein the set of instructions that is executable by the at least one processor of a data-processing device to cause the device to further perform:
receiving a user selection of an alignment method; and
pasting the target data at a location in the input area based on the pasting location information and the selected alignment method indicating how the target data is aligned with the location obtained based on the pasting location information.

41. The non-transitory computer readable medium of claim 34, wherein the set of instructions that is executable by the at least one processor of a data-processing device to cause the device to further perform:
enlarging or shrinking an area of the target data to fit the target data into the location
obtained based on the pasting location information.

42. The non-transitory computer readable medium of claim 34, wherein the set of instructions that is executable by the at least one processor of a data-processing device to cause the device to further perform:
displaying the pasting location information in the input area.
